(19) United States
(12) Patent Application Publication
(10) Pub. No.: US 2026/0181634 A1
(43) Pub. Date: Jun. 25, 2026

(54) METHOD FOR COLLABORATIVE TASK OFFLOADING AND SERVICE CACHING BASED ON GRAPH ATTENTION MULTI-AGENT REINFORCEMENT LEARNING

(71) Applicant: CHONGQING UNIVERSITY OF POSTS AND TELECOMMUNICATIONS, Chongqing (CN)

(72) Inventors: Yun LI, Chongqing (CN); Zhixiu YAO, Chongqing (CN); Shichao XIA, Chongqing (CN); Guangfu WU, Chongqing (CN)

(73) Assignee: CHONGQING UNIVERSITY OF POSTS AND TELECOMMUNICATIONS, Chongqing (CN)

(21) Appl. No.: 18/845,903

(22) PCT Filed: Mar. 18, 2024
(86) PCT No.: PCT/CN2024/082128

§ 371 Date: Sep. 11, 2024

(30) Foreign Application Priority Data
Sep. 8, 2023 (CN) 202311160072.8

(51) Int. Cl. H04W 72/21; H04L 67/568; H04W 72/0446

(52) U.S. Cl. CPC H04W 72/21; H04L 67/568; H04W 72/0446

(57) ABSTRACT

A method for collaborative task offloading and service caching based on graph attention multi-agent reinforcement learning is provided, relating to the technical field of mobile communication. The method includes: constructing an MEC system in a scenario of an MEC network with multiple base stations and diverse service requests; modeling a coordinative task offloading and service caching problem for maximizing a system utility based on QoE; transforming the coordinative task offloading and service caching problem to a decentralized partial observable Markov decision process; and solving the decentralized partial observable Markov decision process by using a graph attention multi-agent reinforcement learning algorithm. Based on simulation experiments, the method according to the present disclosure has significant improvements in cache hit rate, system utility and calculation success rate compared to the conventional methods.

This application claims the priority to Chinese Patent Application No. 202311160072.8 titled “METHOD FOR COLLABORATIVE TASK OFFLOADING AND SERVICE CACHING BASED ON GRAPH ATTENTION MULTI-AGENT REINFORCEMENT LEARNING”, filed on Sep. 8, 2023, with the China National Intellectual Property Administration, which is incorporated herein by reference in its entirety.

### FIELD

The present disclosure relates to the technical field of mobile communication, and in particular to a method for collaborative task offloading and service caching based on graph attention multi-agent reinforcement learning.

### BACKGROUND

Mobile edge computing (MEC), as an effective solution for a large amount of ultra-low latency computing services, provides cloud functions to edge networks closer to user equipments, effectively reducing task processing latency. An MEC server, provided with storage and computing resources, may cache various services (including program codes and databases), so that computing tasks requested by the user equipments (UEs) can be processed on edge networks, thereby reducing service latency of a large amount of emerging applications (such as autonomous driving, augmented reality, and interactive online games).

However, due to limited storage resources, the MEC server can only cache a small portion of popular services simultaneously. In addition, in a densely deployed small cellular network, a large amount of offloading requests of heterogeneous services may cause serious inter-cell interference, resulting in a poor quality of experience (QoE). Apparently, the computation performance of the MEC network is closely related to a strategy for computation offloading and service caching. Therefore, an efficient strategy for task offloading and service caching is essential for improving the QoE of the UEs. Chinese and foreign researchers have conducted extensive and in-depth research on the above problem, and the following results are achieved.

(1) An method for service caching, computation offloading, and resource allocation in mobile edge computing (referring to: Zhang G, Zhang S, Zhang W, et al. Joint Service Caching, Computation Offloading and Resource Allocation in Mobile Edge Computing Systems [J]. IEEE Transactions on Wireless Communications, 2021, 20(8): 5288-5300.) is provided, in which a scenario of multiple user equipments is considered, and transmission, computing resource allocation, service caching and task offloading are jointly optimized to minimize energy consumptions of all the user equipments.

(2) An method for service caching and task offloading in high-altitude platform station assisted intelligent transportation system (referring to: Ren Q, Abbasi O, Kurt G K, et al. Caching and Computation Offloading in High Altitude Platform Station (HAPS) Assisted Intelligent Transportation Systems [J]. IEEE Transactions on Wireless Communications, 2022, 21(11): 9010-9024.) is provided, in which service caching and task offloading in an intelligent transportation scenario are considered, and task offloading, service caching, bandwidths and computing resource allocation decisions are jointly optimized to minimize system latency.

However, with the diversification and regionalization of service requests and the continuous expansion of the scale of the MEC, it is difficult to obtain an efficient strategy for task offloading and resource allocation in the MEC environment by using the conventional optimization methods due to the complex spatial correlation between edge nodes. Specifically, the following spatial correlations should be considered.

(1) The types of service requests of different edge nodes are different, and neighbor nodes generally have the same type of popular service request due to the similarity of the UEs.

(2) An achievable uplink transmission rate of a UE mainly depends on a radio resource allocation strategy and interference from other cells, and cells with a closer distance interfere more to each other.

Therefore, in determining a strategy for task offloading, resource allocation and service caching for an edge node, the service requests and wireless network state information of neighbor edge nodes of the edge node should be considered.

### SUMMARY

To solve the above problems, considering a scenario of collaborative task offloading and service caching in an MEC network with multiple base stations and diverse service requests, and a method for collaborative task offloading and service caching based on graph attention multi-agent reinforcement learning is provided according to the present disclosure.

The method according to the present disclosures includes:
step S1, constructing an MEC system in a scenario of an MEC network with multiple base stations and diverse service requests, where each of the base stations in the MEC system is provided with an MEC server for providing caching and computing resources of a computing service for a user equipment associated with the base station; N={1, 2, . . . , N} represents a set of base stations, where N=|N| and represents the number of the base stations; Mₙ={1, 2, . . . , Mₙ} represents a set of user equipments associated with a base station n∈N, where Mₙ=|Mₙ| and represents the number of the user equipments associated with the base station n; the MEC system has dynamic time slots, T={0, 1, 2, . . . } represents a set of time slots, and each of the time slots has a same time length and is represented by t∈T; and the MEC system further includes a task model, a service caching model, a communication model, a task offloading model and a utility model;
step S2, modeling, based on the MEC system, a coordinative task offloading and service caching problem for maximizing a system utility based on QoE (quality of experience);
step S3, transforming the coordinative task offloading and service caching problem to a decentralized partial observable Markov decision process, including:
   step S31, transforming the coordinative task offloading and service caching problem to the decentralized partial observable Markov decision process with the N base stations, where each of the base stations serves as an agent; and
   step S32, configuring an environment state space, a local observation space, an action space, and a reward function; and
step S4, solving the decentralized partial observable Markov decision process by using a graph attention multi-agent reinforcement learning algorithm, including:
   step S41, constructing a graph attention multi-agent reinforcement learning network, where the graph attention multi-agent reinforcement learning network includes a graph attention module, a joint action-value hybrid module, and a local action-value network corresponding to each of agents;
   step S42, for each of the agents, inputting a local observation value received by the agent and a previous action to a local action-value network corresponding to the agent, and outputting a local action-value function;
   step S43, inputting an environment state of the MEC system to the graph attention module and outputting a weight of the local action-value function by the graph attention module;
   step S44, summing, by the joint action-value hybrid module, all local action-value functions based on the weights to obtain a joint action-value function, and training the joint action-value function based on a minimum loss function; and
   step S45, obtaining a globally optimal strategy for task offloading and service caching based on local observation values of the base stations.

Further, the task model is constructed by: periodically generating, by each of the user equipments, computing tasks with different QoEs and different service requirements, where K={1, 2, . . . , K} represents a set of service types in the MEC system, and K=|K| represents the number of the service types; a computing task generated by a user equipment mₙ∈Mₙ at a time instant t includes six parameters and is represented by

$${φ}_{{m}_{n}}^{t} = \{ {d}_{{m}_{n}}^{t} , {ψ}_{{m}_{n}}^{t} , {ρ}_{{m}_{n}}^{t} , {T}_{{m}_{n}}^{t , min} , {T}_{{m}_{n}}^{t , max} , {T}_{{m}_{n}}^{t , fair} \} ; {d}_{{m}_{n}}^{t}$$

represents the amount of task data of the computing task generated by the user equipment mₙ at the time instant t;

$${ψ}_{{m}_{n}}^{t} ∈ K$$

represents a service type of the computing task generated by the user equipment mₙ at the time instant t;

$${ρ}_{{m}_{n}}^{t}$$

represents the number of CPU cycles required for each bit of input data of the computing task generated by the user equipment mₙ at the time instant t;

$${T}_{{m}_{n}}^{t , min} , {T}_{{m}_{n}}^{t , max} , and {T}_{{m}_{n}}^{t , fair}$$

represent three predetermined service latency thresholds based on the service type of the computing task generated by the user equipment mₙ at the time instant;

$${T}_{{m}_{n}}^{t , min}$$

represents a minimum service latency threshold;

$${T}_{{m}_{n}}^{t , max}$$

represents a maximum service latency threshold; and

$${T}_{{m}_{n}}^{t , fair} ∈ [ {T}_{{m}_{n}}^{t , min} , {T}_{{m}_{n}}^{t , max} ]$$

represents a time instant at which the user equipment mₙ determines a poor QoE.

Further, the service caching model is constructed by: executing, based on a service cached in a base station at a time slot t, a task at a time slot t+1, where a binary variable

$${β}_{n , k}^{t} ∈ \{ 0 , 1 \}$$

represents a service caching decision of a service k in a base station n at the time slot t,

$${β}_{n , k}^{t} = 1$$

in a case that the service k is cached in the base station n, and

$${β}_{n , k}^{t} = 0$$

in a case that the service k is not cached in the base station n.

Further, the communication model is constructed by: dividing a bandwidth of the MEC system into C orthogonal channels, where the C orthogonal channels are assigned at each of the time slots, and the orthogonal channels fully multiplex spectrum resources of the MEC system; C={1, 2, . . . , C} represents a set of available channels of each of the base stations, and

$${α}_{{m}_{n}}^{t , c} ∈ \{ 0 , 1 \}$$

represents a channel assignment variable of the base station n at a time slot t,

$${α}_{{m}_{n}}^{t , c} = 1$$

in a case that the base station n assigns a channel c∈C to a user equipment mₙ, and

$${α}_{{m}_{n}}^{t , c} = 0$$

in a case that the base station n does not assign the channel c∈C to the user equipment mₙ; it is assumed that

$${g}_{{m}_{n} , n}^{t , c}$$

represents a channel gain between the user equipment mₙ and the local base station n of the user equipment mₙ on the channel c in the time slot t, then an uplink transmission rate

$${r}_{{m}_{n} , n}^{t , c}$$

of the user equipment mₙ on the channel c in the time slot t is expressed as:

$${r}_{{m}_{n} , n}^{t , c} = w {log}_{2} ( 1 + \frac{{p}_{{m}_{n}} {g}_{{m}_{n} , n}^{t , c}}{{σ}^{2} + {I}_{n}^{t , c}} )$$

and an uplink transmission rate

$${r}_{{m}_{n} , n}^{t}$$

of the user equipment mₙ at the local base station n in the time slot t is expressed as:

$${r}_{{m}_{n} , n}^{t} = {\sum }_{c ∈ C} {α}_{{m}_{n}}^{t , c} {r}_{{m}_{n} , n}^{t , c}$$

where w represents a bandwidth of a channel, pₘ_{ₙ} represents a transmission power of the user equipment mₙ, σ² represents a background noise power, and

$${I}_{n}^{t , c}$$

represents interference received by the base station n from other user equipments on the channel c in the time slot t.

Further, the task offloading model is constructed by:
determining a local base station offloading strategy and a collaborative offloading strategy for a computing task of each of the user equipments; where

$${b}_{{m}_{n}}^{t} ∈ \{ 0 \} ⋃ N$$

represents a task offloading decision of a user equipment mₙ in a time slot t,

$${b}_{{m}_{n}}^{t} = n$$

in a case that the computing task generated by the user equipment mₙ at a time instant t is offloaded to a local base station n of the user equipment mₙ for execution,

$${b}_{{m}_{n}}^{t} = {n}^{′}$$

in a case that the computing task generated by the user equipment mₙ at the time instant t is offloaded to a base station n′∈N\{n} for execution, and

$${b}_{{m}_{n}}^{t} = 0$$

in a case that the computing task generated by the user equipment mₙ at the time instant t is discarded, where the time slot t represents a time period and the time instant t represents a start time instant of the time slot t;
in a case of selecting the local base station offloading strategy,
   calculating an uplink latency

$${T}_{{m}_{n} , n}^{t , tran}$$

for transmitting the computing task generated by the user equipment mₙ at the time instant t to the local base station n of the user equipment mₙ by using the following equation:

$${T}_{{m}_{n} , n}^{t , tran} = \frac{{d}_{{m}_{n}}^{t}}{{r}_{{m}_{n} , n}^{t}}$$

where

$${d}_{{m}_{n}}^{t}$$

represents the amount of task data of the computing task generated by the user equipment mₙ at the time instant t, and

$${r}_{{m}_{n} , n}^{t}$$

represents an uplink transmission rate of the user equipment mₙ at the local base station n in the time slot t;
calculating a task computing latency

$${T}_{{m}_{n} , n}^{t , comp}$$

of the computing task of the user equipment mₙ at the local base station n by using the following equation:

$${T}_{{m}_{n} , n}^{t , comp} = \frac{{d}_{{m}_{n}}^{t} {ρ}_{{m}_{n}}^{t}}{{f}_{n}}$$

where fₙ represents a CPU frequency of the base station n, and

$${ρ}_{{m}_{n}}^{t}$$

represents the number of CPU cycles required for each bit of input data of the computing task generated by the user equipment mₙ at the time instant t;
calculating a processing latency

$${T}_{{m}_{n} , n}^{t}$$

of offloading the computing task generated by the user equipment mₙ at the time instant t to the local base station n of the user equipment mₙ by using the following equation:

$${T}_{{m}_{n} , n}^{t} = {T}_{{m}_{n} , n}^{t , tran} + {T}_{{m}_{n} , n}^{t , comp}$$

in a case of selecting the cooperative offloading strategy,
   calculating, due to that an additional transmission latency is generated by migrating the computing task generated by the user equipment mₙ at the time instant t to a base station n′, an uplink latency

$${T}_{{m}_{n} , {n}^{′}}^{t , tran}$$

for transmitting the computing task generated by the user equipment mₙ at the time instant t to the base station n′ by using the following equation:

$${T}_{{m}_{n} , {n}^{′}}^{t , tran} = \frac{{d}_{{m}_{n}}^{t}}{{r}_{{m}_{n} , n}^{t}} + \frac{{d}_{{m}_{n}}^{t}}{{\overline{r}}_{n , {n}^{′}}}$$

where r̅_{n,n′} represents an average transmission rate between the base station n and the base station n′;
calculating a task computing latency

$${T}_{{m}_{n} , {n}^{′}}^{t , comp}$$

of the computing task of the user equipment mₙ at the base station n′ by using the following equation:

$${T}_{{m}_{n} , {n}^{′}}^{t , comp} = \frac{{d}_{{m}_{n}}^{t} {ρ}_{{m}_{n}}^{t}}{{f}_{{n}^{′}}}$$

where f_{n′} represents a CPU frequency of the base station n′; and
determining a processing latency

$${T}_{{m}_{n} , {n}^{′}}^{t}$$

for offloading the computing task generated by the user equipment mₙ at the time instant t to the base station n′ by using the following equation:

$${T}_{{m}_{n} , {n}^{′}}^{t} = {T}_{{m}_{n} , {n}^{′}}^{t , tran} + {T}_{{m}_{n} , {n}^{′}}^{t , comp}$$

Further, the utility model is constructed by: defining a utility function to evaluate a quality of experience of the user equipment, where the utility function is expressed as:

$${U}_{{m}_{n}}^{t} = \{ \begin{matrix}1 , & 0 < {T}_{{m}_{n}}^{t} \leq {T}_{{m}_{n}}^{t , min} \\ \frac{{T}_{{m}_{n}}^{t , max} - {T}_{{m}_{n}}^{t}}{{T}_{{m}_{n}}^{t , max} - {T}_{{m}_{n}}^{t , min}} & {T}_{{m}_{n}}^{t , min} < {T}_{{m}_{n}}^{t} \leq {T}_{{m}_{n}}^{t , max} \\ - 1 , & others\end{matrix}$$

where r̅_{n,n′} represents an average transmission rate between the base station n and the base station n′;
calculating a task computing latency

$${T}_{{m}_{n} , {n}^{′}}^{t , comp}$$

of the computing task of the user equipment mₙ at the base station n′ by using the following equation:

$${T}_{{m}_{n} , {n}^{′}}^{t , comp} = \frac{{d}_{{m}_{n}}^{t} {ρ}_{{m}_{n}}^{t}}{{f}_{{n}^{′}}}$$

where f_{n′} represents a CPU frequency of the base station n′; and
determining a processing latency

$${T}_{{m}_{n} , {n}^{′}}^{t}$$

for offloading the computing task generated by the user equipment mₙ at the time instant t to the base station n′ by using the following equation:

$${T}_{{m}_{n} , {n}^{′}}^{t} = {T}_{{m}_{n} , {n}^{′}}^{t , tran} + {T}_{{m}_{n} , {n}^{′}}^{t , comp}$$

Further, the step S32 of configuring an environment state space, a local observation space, an action space and a reward function includes:
in the environment state space, defining

$${s}^{t} = \{ {φ}^{t} , {β}^{t - 1} , {\{ {g}_{n , n}^{t} , {g}_{{n}^{′} , n}^{t} \}}_{n ∈ N , {n}^{′} ∈ N ∖ \{ n \}} \}$$

where s^{t} represents an environment state of the MEC system in a time slot t,

$${φ}^{t} = {\{ {φ}_{{m}_{n}}^{t} \}}_{n ∈ N , {m}_{n} ∈ {M}_{n}}$$

represents a set of task computing requirement information requested by all the user equipments at the time instant t;

$${φ}_{{m}_{n}}^{t}$$

represents a computing task generated by a user equipment mₙ at the time instant t;

$${g}_{n , n}^{t} = {\{ {g}_{{m}_{n} , n}^{t , c} \}}_{{m}_{n} ∈ {M}_{n} , c ∈ C}$$

represents a set of channel gains of all user equipments associated with the base station n on a channel;

$${g}_{{m}_{n} , n}^{t , c}$$

represents a channel gain between the user equipment mₙ and a local base station n of the user equipment mₙ on a channel c in the time slot t;

$${g}_{{n}^{′} , n}^{t} = {\{ {g}_{{m}_{{n}^{′}} , n}^{t , c} \}}_{{n}^{′} ∈ N ∖ \{ n \} , {m}_{{n}^{′}} ∈ {M}_{{n}^{′}} , c ∈ C}$$

represents a set of interference channel gains between other user equipments and the base stations n on a channel;

$${g}_{{m}_{{n}^{′}} , n}^{t , c}$$

represents an interference channel gain between a user equipment m_{n′} and the base station n on the channel c in the time slot t; and

$${β}^{t - 1} = {\{ {β}_{n , k}^{t - 1} \}}_{n ∈ N , k ∈ K}$$

represents a set of service caching decisions at a time instant t−1;
in the local observation space, defining

$${o}_{n}^{t} = \{ {φ}_{n}^{t} , {β}^{t - 1} , {g}_{n , n}^{t} \}$$

where

$${o}_{n}^{t}$$

represents a local observation value of an agent n in the time slot t;
in the action space, defining

$${a}_{n}^{t} = \{ {β}_{n}^{t} , {α}_{n}^{t} , {b}_{n}^{t} \}$$

where

$${a}_{n}^{t}$$

represents an action space of the agent n in the time slot t,

$${β}_{n , k}^{t}$$

$${β}_{n}^{t} = {\{ {β}_{n , k}^{t} \}}_{k ∈ K}$$

represents a service caching decision of the agent n, and represents a service caching decision of a service k in the base station n in the time slot t,

$${α}_{n}^{t} = {\{ {α}_{{m}_{n}}^{t , c} \}}_{{m}_{n} ∈ {M}_{n} , c ∈ C}$$

represents channel allocation decisions of all user equipments within a coverage region of the agent n,

$${α}_{{m}_{n}}^{t , c}$$

represents a channel allocation variable of the user equipment mₙ in the time slot t,

$${b}_{n}^{t} = {\{ {b}_{{m}_{n}}^{t} \}}_{{m}_{n} ∈ {M}_{n}}$$

represents task offloading decisions of all the user equipments within the coverage region of the agent n, and

$${b}_{{m}_{n}}^{t}$$

represents a task offloading decision of the user equipment mₙ in the time slot t; and
defining the reward function as:

$${r}^{t} = R ( {s}^{t} , {a}^{t} ) = {\sum }_{n ∈ N} {\sum }_{{m}_{n} ∈ {M}_{n}} {U}_{{m}_{n}}^{t}$$

where r^{t} represents rewards obtained by all agents in the time slot t, a^{t} represents a joint action of all the agents in the time slot t,

$${U}_{{m}_{n}}^{t}$$

represents a utility obtained by the user equipment mₙ in the time slot t, and R( ) represents a reward function related to s^{t} and a^{t}.

Further, the step S43 of inputting an environment state of the MEC system to the graph attention module and outputting a weight of the local action-value function by the graph attention module includes:
step S431, constructing a multi-agent environment of the MEC system as an undirected graph G(V,E), where V represents a set of nodes, each of the nodes represents an agent, E represents a set of edges connecting the nodes, and each of the nodes has a set Bₙ⊆N of neighbor nodes determined by the set E of edges;
step S432, inputting the environment state s^{t} to an MLP encoder at the time slot t to output a local latent representation vector

$$( {h}_{1}^{t} , {h}_{2}^{t} , … , {h}_{N}^{t} ) ,$$

and inputting the local latent representation vector to a GAT network, where

$${h}_{n}^{t}$$

represents a local latent representation vector of the node n;
step S433, calculating, for each of the node, an attention coefficient between the node and a neighbor node of the node using a self-attention mechanism of the GAT network, and normalizing the attention coefficient using a softmax function to obtain a normalized attention coefficient; and
step S434, calculating, for each of the node, an output feature representation vector of the node using a multi-head attention mechanism based on the normalized attention coefficient, and inputting the calculated output feature representation vector to the MLP network to obtain the weight of the local action-value function of each of the agents.

Further, the loss function in step S44 is expressed as:

$$L ( θ ) = {\sum }_{x = 1}^{X} ( {y}_{tot}^{x} - {Q}_{tot} ( τ , a ; θ ) )$$

$${y}_{tot} = r + {γmax}_{{a}^{′}} {Q}_{tot} ( {τ}^{′} , {a}^{′} ; {θ}^{-} )$$

where θ represents a parameter of a prediction network, X represents the number of samples randomly sampled from an experience replay pool, x represents a sample number, θ⁻ represents a target network parameter, r represents rewards of all the agents in a current time slot, γ represents a discount factor, τ′ represents an observation history of a joint action of all the agents in a next time slot, a′ represents the joint action of all the agents in the next time slot, and Qₜₒₜ( ) represents a joint action-value function of all the agents in the current time slot.

The following beneficial effects can be achieved according to the present disclosure.

To solve the problem of cooperative task offloading and service caching in the MEC network with multiple base stations and diverse service requests, a multi-agent reinforcement learning method based on graph attention is provided according to the present disclosure. A scenario of an MEC network with multiple base stations and diverse service requests is modeled, and a QoE-based utility function is introduced to indicate a degree of satisfaction of a UE for service latency. Under the constraint of the storage resources and radio resources, the optimization problem is modeled as a cooperative task offloading and service caching problem to maximize the QoE-based system utility. A multi-agent reinforcement learning method based on graph attention is provided to learn the optimal strategy for task offloading and service caching. Through simulation experiments, the method according to the present disclosure has significant improvements in cache hit rate, system utility and calculation success rate compared with the conventional methods.

### BRIEF DESCRIPTION OF THE DRAWINGS

FIG. 1 is a flowchart of a method for collaborative task offloading and service caching based on graph attention multi-agent reinforcement learning according to the present disclosure;

FIG. 2 is a model diagram of a system according to the present disclosure;

FIG. 3 is a schematic diagram of an utility function according to the present disclosure;

FIG. 4 is a schematic diagram shows an architecture of a method for collaborative task offloading and service caching based on graph attention multi-agent reinforcement learning according to the present disclosure;

FIG. 5 is a schematic diagram of a simulation scenario according to an embodiment of the present disclosure;

FIG. 6 is a schematic diagram showing changes of a cache hit rate, a system utility and a computation success rate with a storage capacity of a base station using different algorithms according to the present disclosure; and

FIG. 7 is a schematic diagram showing changes of a cache hit rate, an average utility of users, and a computation success rate with the number of the users using different algorithms according to the present disclosure.

### DETAILED DESCRIPTION OF THE EMBODIMENTS

The technical solutions according to the embodiments of the present disclosure will be described clearly and completely as follows in conjunction with the drawings in the embodiments of the present disclosure. It is apparent that the described embodiments are only some of the embodiments according to the present disclosure, rather than all the embodiments. Based on the embodiments in the present disclosure, any other embodiments obtained by those skilled in the art without any creative efforts fall within the protection scope of the present disclosure.

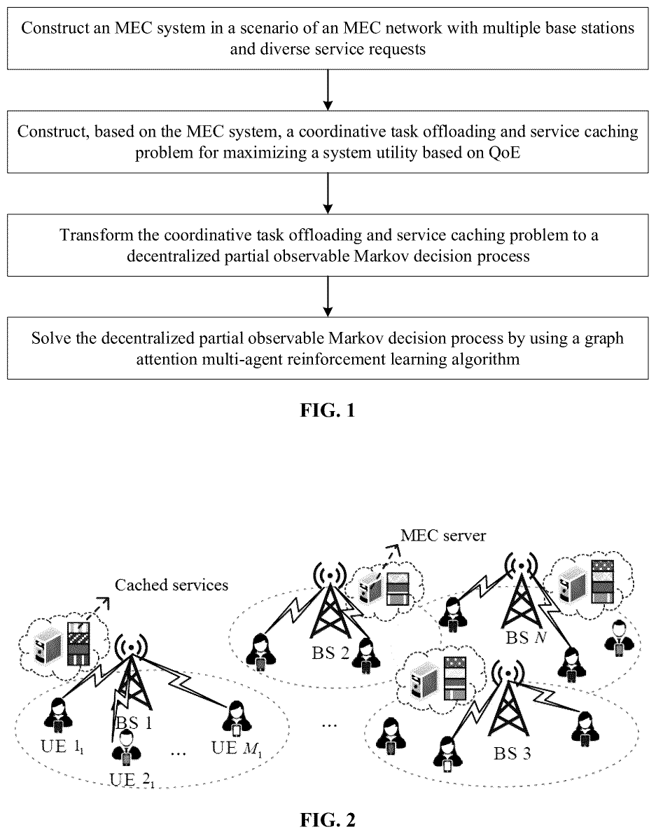

According to the present disclosure, a method for collaborative task offloading and service caching based on graph attention multi-agent reinforcement learning is provided. As shown in FIG. 1, the method includes the following steps S1 to S4.

In step S1, an MEC system is constructed in a scenario of an MEC network with multiple base stations.

In step S2, a coordinative task offloading and service caching problem is modeled based on the MEC system for maximizing a system utility based on QoE.

In step S3, the coordinative task offloading and service caching problem is transformed to a decentralized partial observable Markov decision process.

In step S4, the transformed decentralized partial observable Markov decision process is solved by using a graph attention multi-agent reinforcement learning algorithm.

In a first embodiment, as shown in FIG. 2, an MEC system includes N base stations (BSs). Each of the base stations in the MEC system is provided with an MEC server for providing caching and computing resources of a computing service for a user equipment associated with the base station. N={1, 2, . . . , N} represents a set of base stations, where N=|N| and represents the number of the base stations. Mₙ={1, 2, . . . , Mₙ} represents a set of user equipments associated with a BSn (that is, a base station n∈), where Mₙ=|Mₙ| and represents the number of the user equipments associated with BSn. The MEC system has dynamic time slots. T={0, 1, 2, . . . } represents a set of time slots, and each of the time slots has a same time length and is represented by t∈T. The MEC system further includes a task model, a service caching model, a communication model, a task offloading model, and a utility model.

In an embodiment, the task model is constructed by: periodically generating, by each of the user equipments, computing tasks with different QoEs and different service requirements. After a computational task with a service requirement is generated, it is required to configure data (such as program codes and a database) corresponding to the service for processing the computing task. K={1, 2, . . . , K} represents a set of service types in the MEC system, and K=|K| represents the number of the service types. A computing task generated by a UEmₙ (that is, a user equipment mₙ∈Mₙ) at a time instant t includes six parameters and is represented by

$${φ}_{{m}_{n}}^{t} = \{ {d}_{{m}_{n}}^{t} , {ψ}_{{m}_{n}}^{t} , {ρ}_{{m}_{n}}^{t} , {T}_{{m}_{n}}^{t , min} , {T}_{{m}_{n}}^{t , max} , {T}_{{m}_{n}}^{t , fair} \} \cdot {d}_{{m}_{n}}^{t}$$

represents the amount of task data of the computing task generated by UEmₙ at the time instant t,

$${ψ}_{{m}_{n}}^{t} ∈ K$$

represents a service type of the computing task generated by UEmₙ at the time instant t,

$${ρ}_{{m}_{n}}^{t}$$

represents the number of CPU cycles required for each bit of input data of the computing task generated by UEmₙ at the time instant t, and

$${T}_{{m}_{n}}^{t , min} , {T}_{{m}_{n}}^{t , max} , and {T}_{{m}_{n}}^{t , fair}$$

represent three predetermined service latency thresholds based on the service type of the computing task generated by UEmₙ at the time instant t.

$${T}_{{m}_{n}}^{t , min}$$

represents a minimum service latency threshold, and UEmₙ cannot perceive improvement of QoE even if the service latency is less than the minimum service latency threshold.

$${T}_{{m}_{n}}^{t , max}$$

represents a maximum service latency threshold. In a case that the service latency is greater than

$${T}_{{m}_{n}}^{t , max} ,$$

it indicates that the QoE exceeds an acceptable range, that is, the task fails; and in a cased that the service latency is greater than

$${T}_{{m}_{n}}^{t , min}$$

and less than

$${T}_{{m}_{n}}^{t , max} ,$$

it indicated that the QoE of UEmₙ is within the acceptable range and may decrease as the service latency increases.

$${T}_{{m}_{n}}^{t , fair} ∈ [ {T}_{{m}_{n}}^{t , min} , {T}_{{m}_{n}}^{t , max} ]$$

represents a time instant at which UEmₙ determines a poor QoE.

Specifically, the service caching model is constructed by performing the following operations. BSs with cache and computing capabilities may cache services required by computation-intensive applications and latency-sensitive applications, so that corresponding tasks are processed at edge networks without being processed by a remote cloud center. However, the BSs with limited storage capacity cannot cache all the services. It is required for the BSs to determine the type of service that should be cached. A binary variable

$${β}_{n , k}^{t} ∈ \{ 0 , 1 \}$$

is defined and represents a service caching decision of a service k in BSn in the time slot t. In a case that the service k is cached in BSn,

$${β}_{n , k}^{t} = 1 ;$$

and in a case that the service k is not cached in BSn

$${β}_{n , k}^{t} = 0 .$$

In addition, the service cached in the base station in the time slot t may be used to perform a corresponding task in the time slot t+1.

Specifically, the communication model is constructed by performing the following operations. According to the present disclosure, a MEC system based on orthogonal frequency division multiple access (OFDMA) is considered. The bandwidth of the system is divided into C orthogonal channels. The C orthogonal channels may be allocated in each of the time slots, and the orthogonal channels fully multiplex spectrum resources of the system. Therefore, an uplink transmission of a UE to a local BS of the UE suffers from an inter-cell interference caused by uplink transmissions from UEs in other BSs. C={1, 2, . . . , C} represents a set of available channels of each of the BSs, and

$${α}_{{m}_{n}}^{t , c} ∈ \{ 0 , 1 \}$$

represents a channel assignment variable in the time slot t.

$${α}_{{m}_{n}}^{t , c} = 1$$

in a case that the BSn assigns a channel c∈C to UEmₙ, and

$${α}_{{m}_{n}}^{t , c} = 0$$

in a case that the BSn does not assign the channel c∈C to the UEmₙ.

It is assumed that

$${g}_{{m}_{n} , n}^{t , c}$$

represents a channel gain between the UEmₙ and the local BSn of the UEmₙ on the channel c in the time slot t, then an uplink transmission rate

$${r}_{{m}_{n} , n}^{t , c}$$

of the UEmₙ on the channel c in the time slot t is expressed as:

$${r}_{{m}_{n} , n}^{t , c} = w {log}_{2} ( 1 + \frac{{p}_{{m}_{n}} {g}_{{m}_{n} , n}^{t , c}}{{σ}^{2} + {I}_{n}^{t , c}} ) \qquad ( 1 )$$

where w represents a bandwidth of the channel, pₘ_{ₙ} represents a transmit power of the UEmₙ, σ² represents a background noise power, and

$${I}_{n}^{t , c}$$

represents an interference received by the BSn from other user equipments on the channel c in the time slot t and is expressed as:

$${I}_{n}^{t , c} = {\sum }_{{n}^{′} ∈ N \backslash \{ n \}} {\sum }_{{m}_{{n}^{′}} ∈ {M}_{{n}^{′}}} {α}_{{m}_{{n}^{′}}}^{t , c} {p}_{{m}_{{n}^{′}}} {g}_{{m}_{{n}^{′}} , n}^{t , c} \qquad ( 2 )$$

where

$${g}_{{m}_{{n}^{′}} , n}^{t , c}$$

represents an interference channel gain between UEmₙ and BSn on the channel c.

On the basis of the above assumption, an uplink transmission rate

$${r}_{{m}_{n} , n}^{t}$$

of the UEmₙ in the local BSn in the time slot t is expressed as:

$${r}_{{m}_{n} , n}^{t} = {\sum }_{c ∈ C} {α}_{{m}_{n}}^{t , c} {r}_{{m}_{n} , n}^{t , c} \qquad ( 3 )$$

Specifically, the task offloading model is constructed by performing the following operations. According to the present disclosure, BSs collaboratively provide computing services for UEs. Specifically, each of the UEs has the following two offloading strategies: (1) offloading a task to an MEC server of a local BS to be executed, and (2) migrating, by the local BS, the task to an MEC server of another BS that has cached the service to be executed if the local BS does not cache the service type requested by the UE.

$${b}_{{m}_{n}}^{t} ∈ \{ 0 \} ⋃ N$$

represents a task offloading decision of the UEmₙ in the time slot t. In a case that the computing task generated by the UEmₙ at a time instant t is offloaded to a local BSn of the user equipment mₙ for execution,

$${b}_{{m}_{n}}^{t} = n ;$$

in a case that the computing task generated by the UEmₙ at the time instant t is offloaded to a BSn′ (where n′∈N\{n}) for execution,

$${b}_{{m}_{n}}^{t} = {n}^{′} ;$$

and in a case that the computing task generated by the UEmₙ at the time instant t is discarded,

$${b}_{{m}_{n}}^{t} = 0.$$

The time slot t represents a time period and the time instant t represents a start instant of the time slot t.

The task offloading model includes a local base station offloading model and a collaborative offloading model.

(1) For the local base station offloading model, after the UE decides to offload a task to a local BS, the task is uploaded to the BS and then is executed on an edge server provided at the BS. After executing the task, the local BS returns a calculation result to the UE. An uplink transmission latency and a task calculation latency are considered in the present disclosure. Due to the small amount of data in the calculation result, the latency for transmitting the calculation results is ignored. Based on the above communication model, an uplink latency

$${T}_{{m}_{n} , n}^{t , tran}$$

for transmitting the computing task generated by the UEmₙ at the time instant t to the local BSn of the UEmₙ is calculated by using the following equation:

$${T}_{{m}_{n} , n}^{t , tran} = \frac{{d}_{{m}_{n}}^{t}}{{r}_{{m}_{n}}^{t}} \qquad ( 4 )$$

where

$${d}_{{m}_{n}}^{t}$$

represents the amount of the task data of the computing task generated by the UEmₙ at the time instant t, and

$${r}_{{m}_{n} , n}^{t}$$

represents the uplink transmission rate of the UEmₙ at the local BSn in the time slot t.

The MEC server configured at the local BS processes the computing tasks. A task computing latency

$${T}_{{m}_{n} , n}^{t , comp}$$

of a computing task of the UEmₙ at the local BSn is calculated by using the following equation:

$${T}_{{m}_{n} , n}^{t , comp} = \frac{{d}_{{m}_{n}}^{t} {ρ}_{{m}_{n}}^{t}}{{f}_{n}} \qquad ( 5 )$$

where fₙ represents a CPU frequency of the BSn, and

$${ρ}_{{m}_{n}}^{t}$$

represents the number of CPU cycles required for each bit of input data of the computing task generated by the UEmₙ at the time instant t.

Based on the task communication latency and the task computing latency, a processing latency

$${T}_{{m}_{n} , n}^{t}$$

for offloading the computing task generated by the UEmₙ at the time instant t to the local BSn of the UEmₙ is calculated by using the following equation:

$${T}_{{m}_{n} , n}^{t} = {T}_{{m}_{n} , n}^{t , tran} + {T}_{{m}_{n} , n}^{t , comp} \qquad ( 6 )$$

(2) For the cooperative offloading model, an additional transmission latency may be generated in a case that a task is migrated to another BS to be executed. To simplify the system model, it is assumed that r̅_{n,n′} represents an average transmission rate between the BSn and the BSn′, then an uplink latency

$${T}_{{m}_{n} , {n}^{′}}^{t , t r a n}$$

for transmitting the computing task generated by the UEmₙ at the time instant t to the BSn′ is calculated by using the following equation:

$${T}_{{m}_{n} , {n}^{′}}^{t , tran} = \frac{{d}_{{m}_{n}}^{t}}{{r}_{{m}_{n} , n}^{t}} + \frac{{d}_{{m}_{n}}^{t}}{{\overline{r}}_{n , {n}^{′}}} \qquad ( 7 )$$

A task computing latency

$${T}_{{m}_{n} , {n}^{′}}^{t , comp}$$

of the computing task of the UEmₙ at the BSn′ is calculated by using the following equation:

$${T}_{{m}_{n} , {n}^{′}}^{t , comp} = \frac{{d}_{{m}_{n}}^{t} {ρ}_{{m}_{n}}^{t}}{{f}_{{n}^{′}}} \qquad ( 8 )$$

where f_{n′} represents a CPU frequency of the BSn′.

A processing latency

$${T}_{{m}_{n} , {n}^{′}}^{t}$$

for offloading the computing task generated by the UEmₙ at the time instant t to the BSn′ is determined by using the following equation:

$${T}_{{m}_{n} , {n}^{′}}^{t} = {T}_{{m}_{n} , {n}^{′}}^{t , tran} + {T}_{{m}_{n} , {n}^{′}}^{t , comp} \qquad ( 9 )$$

After obtaining a service cache state (that is, a service cache decision in the time slot t−1) in the time slot t and the task offloading decision and the channel allocation decision in the time slot t, a service latency of the UEmₙ requesting a k-th service may be expressed as:

$${T}_{{m}_{n}}^{t} = {T}_{{m}_{n} , n}^{t} 1 \{ {\sum }_{c = 1}^{C} {α}_{{m}_{n}}^{t , c} = 1 , {β}_{n , k}^{t - 1} = 1 , {b}_{{m}_{n}}^{t} = n \} + {T}_{{m}_{n} , {n}^{′}}^{t} 1 \{ {\sum }_{c = 1}^{C} {α}_{{m}_{n}}^{t , c} = 1 , {β}_{{n}^{′} , k}^{t - 1} = 1 , {b}_{{m}_{n}}^{t} = {n}^{′} \} \qquad ( 10 )$$

where 1_{{⋅}} represents an indication function, 1_{{⋅}}=1 in a case that an event {⋅} is true, and 1_{{⋅}}=0 in a case that the event {⋅} is not true.

The utility model is constructed by performing the following operations. To evaluate a QoE of a UE, a utility function based on a service latency is used in the present disclosure. The utility function is expressed as:

$${U}_{{m}_{n}}^{t} = \{ \begin{matrix}1 , & 0 < {T}_{{m}_{n}}^{t} \leq {T}_{{m}_{n}}^{t , min} \\ \frac{{T}_{{m}_{n}}^{t , max} - {T}_{{m}_{n}}^{t}}{{T}_{{m}_{n}}^{t , max} - {T}_{{m}_{n}}^{t , min}} , & {T}_{{m}_{n}}^{t , min} < {T}_{{m}_{n}}^{t} \leq {T}_{{m}_{n}}^{t , max} \\ - 1 , & others\end{matrix}$$

where

$${U}_{{m}_{n}}^{t}$$

represents an utility obtained by a user equipment mₙ in a time slot t,

$${T}_{{m}_{n}}^{t}$$

represents a service latency for processing a computing task generated by the user equipment mₙ at the time instant t,

$${T}_{{m}_{n}}^{t , min}$$

represents a minimum service latency requirement of the computing task generated by the user equipment mₙ at the time instant t, and

$${T}_{{m}_{n}}^{t , max}$$

represents a maximum service latency requirement of the computing task generated by the user equipment mₙ at the time instant t.

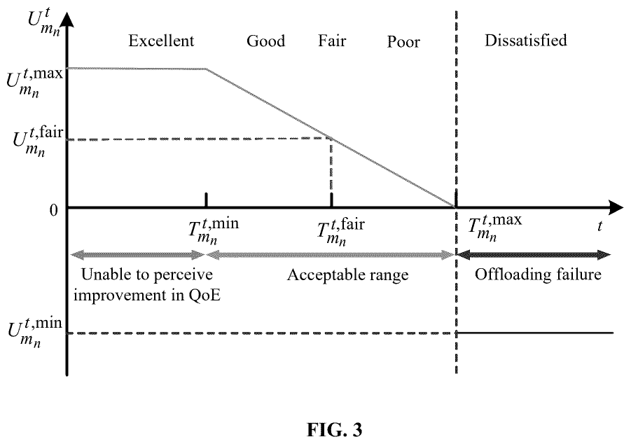

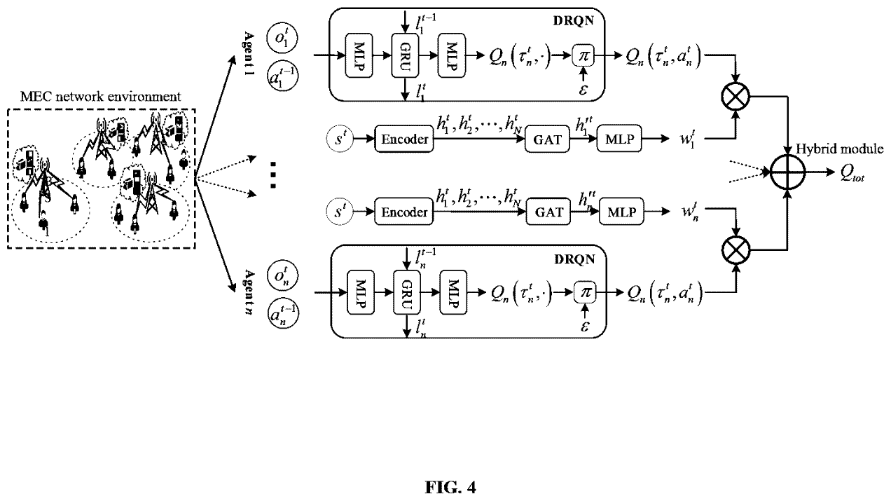

As shown in FIG. 3, the utility function is a non-increasing piecewise linear utility function. The utility function maps service latencies of all the UEs to an average opinion rating scale, including excellent, good, fair, poor, and dissatisfied. Specifically, in a case that

$${T}_{{m}_{n}}^{t} \leq {T}_{{m}_{n}}^{t , min} ,$$

the UEmₙ has an excellent QoE, and even if the service latency is less than

$${T}_{{m}_{n}}^{t , min} ,$$

the UEmₙ cannot perceive an improvement of QoE. In this case, the utility is unchanged, that is,

$${U}_{{m}_{n}}^{t , max} = 1.$$

In a case that the service latency meets

$${T}_{{m}_{n}}^{t , min} < {T}_{{m}_{n}}^{t} \leq {T}_{{m}_{n}}^{t , max} ,$$

the QoE of the UEmₙ is within an acceptable range and decreases as the service latency increases, and the utility ranges from 0 to 1. In this case,

$${T}_{{m}_{n}}^{t , fair} ∈ [ {T}_{{m}_{n}}^{t , min} , {T}_{{m}_{n}}^{t , max} ]$$

is used to represent a critical latency at which the UEmₙ determines a poor QoE according to the present disclosure. As shown in FIG. 3, in a case that

$${T}_{{m}_{n}}^{t , min} < {T}_{{m}_{n}}^{t} \leq {T}_{{m}_{n}}^{t , fair} ,$$

the UEmₙ has a good QoE; and in a case that

$${T}_{{m}_{n}}^{t , fair} < {T}_{{m}_{n}}^{t} \leq {T}_{{m}_{n}}^{t , max} ,$$

the UEmₙ has a poor QoE. It should be noted that

$${T}_{{m}_{n}}^{t , fair}$$

does not change a slope of the utility function, and the utility function is only affected by

$${T}_{{m}_{n}}^{t , min} and {T}_{{m}_{n}}^{t , max} .$$

In a case that

$${T}_{{m}_{n}}^{t} > {T}_{{m}_{n}}^{t , max} ,$$

the service latency exceeds the acceptable range, and a dissatisfied QoE is achieved, indicating that corresponding task offloading is failed and the utility is negative, that is,

$${U}_{{m}_{n}}^{t , min} = - 1.$$

In a second embodiment, based on the models constructed in the first embodiment, a cooperative task offloading and service caching problem is modeled as follows for determining strategies for task offloading, channel allocation and service caching to maximize the total utility of all the UEs in the network:

$${max}_{β , α , b} {\sum }_{t ∈ T} {\sum }_{n ∈ N} {\sum }_{{m}_{n} ∈ {M}_{n}} {U}_{{m}_{n}}^{t} \qquad ( 12 )$$

where the following constraints are included:

$$C 1 : {β}_{n , k}^{t} ∈ \{ 0 , 1 \} , ∀ n , k , t ,$$

$$C 2 : {α}_{{m}_{n}}^{t , c} ∈ \{ 0 , 1 \} , ∀ n , {m}_{n} , c , t ,$$

$$C 3 : {b}_{{m}_{n}}^{t} ∈ \{ 0 \} ⋃ N , ∀ n , {m}_{n} , t ,$$

$$C 4 : {\sum }_{k ∈ K} {β}_{n , k}^{f} {z}_{k} \leq {Z}_{n} , ∀ n , k , t ,$$

$$C 5 : {\sum }_{c ∈ C} {α}_{{m}_{n}}^{t , c} \leq 1 , ∀ n , {m}_{n} , t ,$$

$$C 6 : {\sum }_{{m}_{n} ∈ {M}_{n}} {α}_{{m}_{n}}^{t , c} \leq 1 , ∀ n , c , t ,$$

In the above constraints,

$$β = {\{ {β}_{n , k}^{t} \}}_{n ∈ N , k ∈ K , t ∈ T}$$

represents a set of service caching decisions,

$$a = {\{ {α}_{{m}_{n}}^{t , c} \}}_{n ∈ N , {m}_{n} ∈ {M}_{n} , c ∈ C , t ∈ T}$$

represents a set of channel assignment decisions, and

$$b = {\{ {b}_{{m}_{n}}^{t} \}}_{n ∈ N , {m}_{n} ∈ {M}_{n} , t ∈ T}$$

represents a set of offloading decisions. The constraint C4 indicates that services cached in a BS cannot exceed a storage capacity of the BS, where Zₙ represents a storage capacity of BSn and zₖ represents a storage space required for caching a service k∈K. According to the present disclosure, it is assumed that each of the BSs in the network may exchange service cache information at a beginning of a time slot. Since all the BSs communicate using OFDMA, the constraint C5 indicates that a UE can only be assigned with one channel, and the constraint C6 indicates that a channel in a BS can only be assigned to one UE.

Specifically, the problem in equation (12) may be solved by determining optimal decision variables β, α, and b in all time slots. However, the large number of states makes the problem complex. Moreover, the distributed dynamic MEC environment is considered according to the present disclosure, and the BSs in the environment cannot obtain complete system information. Therefore, it is difficult to solve the problem using the conventional optimization methods. The problem in equation (12) may be transformed to a decentralized partial observable Markov decision process (Dec-POMDP) and then is solved by using a multi-agent reinforcement learning (MARL) algorithm. In addition, in the present disclosure, a graph attention network (GAT) is combined with MARL to capture a potential spatial correlation between BSs for performing cooperative learning.

In a third embodiment, the problem proposed in the second embodiment is transformed to a decentralized partial observable Markov decision process with N base stations, and each of the base stations serves as an agent. Specifically, a tuple [symbol] S, {Oₙ}_{n∈N}, {Aₙ}_{m∈N}, R, γ [symbol] is used to describe the Dec-POMDP, where S represents environment states of all agents, Oₙ represents a set of local observation spaces of an agent n, Aₙ represents a set of action spaces of the agent n, R represents a reward function, and γ∈[0,1) represents a discount factor. At the time instant t, each of the agents n receives a local observation value

$${o}_{n}^{t} ∈ {O}_{n}$$

and determines an action

$${a}_{n}^{t} ∈ {A}_{n} .$$

Then, a joint action of all the agents may be obtained, which is expressed as a^{t}∈A=A₁× . . . ×A_{N}. After the agents perform the joint action, the environment returns a global reward r^{t}=R(s^{t}, a^{t}), and the agents transitions to a next state s^{t+1}. According to the present disclosure, an environment state space, a local observation space, an action space and a reward function of the BSs at the time instant t are defined.

Specifically, at the time instant t, the environment state includes task computing requirement information of all the UEs, a wireless channel state in the network, and a current service caching state of all the base stations. Therefore, the environment state space s^{t}∈S is defined as

$${s}^{t} = \{ {φ}^{t} , {β}^{t - 1} , {\{ {g}_{n , n}^{t} , {g}_{{n}^{′} , n}^{t} \}}_{n ∈ N , {n}^{′} ∈ N ∖ \{ n \}} \} \qquad ( 13 )$$

where s^{t} represents an environment state of the MEC system in the time slot t;

$${φ}^{t} = {\{ {φ}_{{m}_{n}}^{t} \}}_{n ∈ N , {m}_{n} ∈ {M}_{n}}$$

represents a set of task computing requirement information requested by all the UEs at the time instant t;

$${φ}_{{m}_{n}}^{t}$$

represents a computing task generated by UEmₙ at the time instant t, where a task computing requirement of the UEmₙ includes the amount

$${d}_{{m}_{n}}^{t}$$

of task data, the service type

$${ψ}_{{m}_{n}}^{t}$$

and the required computing resources

$${ρ}_{{m}_{n}}^{t}$$

(in CPU cycles/bit) of the computing task generated at the time instant t, and three predefined service latency thresholds

$${T}_{{m}_{n}}^{t , min} , {T}_{{m}_{n}}^{t , max} , and {T}_{{m}_{n}}^{t , f a i r} ; {g}_{n , n}^{t} = {\{ {g}_{{m}_{n} , n}^{t , c} \}}_{{m}_{n} ∈ {M}_{n} , c ∈ C}$$

represents a set of channel gains of all UEs associated with BSn on a channel;

$${g}_{{m}_{n} , n}^{t , c}$$

represents a channel gain between the user equipment mₙ and a local base station n of the user equipment mₙ on a channel c during the time slot t;

$${g}_{{n}^{′} , n}^{t} = {\{ {g}_{{m}_{{n}^{′}} , n}^{t , c} \}}_{{n}^{′} ∈ N ∖ \{ n \} , {m}_{{n}^{′}} ∈ {M}_{{n}^{′}} , c ∈ C}$$

represents a set of interference channel gains between other user equipments and the base station n on a channel;

$${g}_{{m}_{{n}^{′}} , n}^{t , c}$$

represents an interference channel gain between a user equipment m_{n′} and the base station n on the channel c in the time slot t; and

$${β}^{t - 1} = {\{ {β}_{n , k}^{t - 1} \}}_{n ∈ N , k ∈ K}$$

represents a set of service caching decisions in a time slot t−1.

Specifically, in a partial observable MEC environment, a local observation value of an agent n in the time slot t may be expressed as:

$${o}_{n}^{t} = \{ {φ}_{n}^{t} , {β}^{t - 1} , {g}_{n , n}^{t} \} \qquad ( 14 )$$

where

$${o}_{n}^{t}$$

represents a local observation value of the agent n in the time slot t. The agents may exchange service caching information with all the BSs at the beginning of the time slot t, so that the agents may observe the service caching states of all the BSs, that is, β^{t-1}.

Specifically, according to the problem in equation (12), an action space of the agent n in the time slot t may be expressed as:

$${a}_{n}^{t} = \{ {β}_{n}^{t} , {α}_{n}^{t} , {b}_{n}^{t} \} \qquad ( 15 )$$

where

$${a}_{n}^{t}$$

represents an action space of the agent n in the time slot t,

$${β}_{n}^{t} = {\{ {β}_{n , k}^{t} \}}_{k ∈ K}$$

represents a service caching decision of the agent n, and

$${β}_{n , k}^{t}$$

represents a service caching decision of a service k in the base station n in the time slot t,

$${a}_{n}^{t} = {\{ {α}_{{m}_{n}}^{t , c} \}}_{{m}_{n} ∈ {M}_{n} , c ∈ C}$$

represents channel allocation decisions of all user equipments within a coverage region of the agent n,

$${α}_{{m}_{n}}^{t , c}$$

represents a channel allocation variable of the user equipment mₙ in the time slot t,

$${b}_{n}^{t} = {\{ {b}_{{m}_{n}}^{t} \}}_{{m}_{n} ∈ {M}_{n}}$$

represents task offloading decisions of all the user equipments within the coverage region of the agent n, and

$${b}_{{m}_{n}}^{t}$$

represents a task offloading decision of the user equipment mₙ in the time slot t.

Specifically, after performing the joint action a^{t}, the environment returns a reward r^{t} to evaluate the joint action. According to the equation (12), the agent is to maximize the sum of the QoE-based utilities of all associated UEs. Therefore, the reward function of the MEC system may be defined as:

$${r}^{t} = R ( {s}^{t} , {a}^{t} ) = {\sum }_{n ∈ N} {\sum }_{{m}_{n} ∈ {M}_{n}} {U}_{{m}_{n}}^{t} \qquad ( 16 )$$

where r^{t} represents rewards obtained by all agents in the time slot t, a^{t} represents a joint action of all the agents in the time slot t,

$${U}_{{m}_{n}}^{t}$$

represents a utility obtained by the user equipment mₙ in the time slot t, and R( ) represents a reward function related to s^{t} and a^{t}.

In the partial observable environment, each of the agents n receives a local observation value

$${o}_{n}^{t} ,$$

and determines an action

$${a}_{n}^{t}$$

based on a local strategy πₙ(aₙ|τₙ) of the agent, where τₙ represents an action observation history. π={πₙ}_{n∈N} represents a joint strategy of all the agents. The agents learn a joint optimization strategy for task offloading, channel assignment, and service caching to maximize the discounted cumulative global reward

$${\sum }_{i ∈ T} {γ}^{i} {r}^{t + i} .$$

Therefore, a joint-action value function may be expressed as:

$${Q}^{π} ( {s}^{t} , {a}^{t} ) = E [ {\sum }_{i ∈ T} {γ}^{i} {r}^{t + i} \vert {s}^{t} , {a}^{t} ] \qquad ( 17 )$$

where E[⋅] represents an expectation operation, the joint-action value function Q^{π}(s^{t},a^{t}) represents an expectation of the discounted cumulative global reward with an initial state s^{t}, an initial joint strategy π and an initial action a^{t}, and an optimal joint strategy π* is a joint strategy for maximizing Q^{π}(s^{t},a^{t}).

In a fourth embodiment, for the conventional MARL methods, such as the independent Q-learning, are feasible for solving a Dec-POMDP with N BSs. However, the conventional methods have the following problems. (1) The agents update the strategy for task offloading and resource allocation in the learning process, resulting in an unstable training environment of the agents and low learning efficiency. (2) The potential spatial correlation between agents cannot be effectively used. For example, different BSs have different popular service requests, and neighbor BSs generally have similar popular service requests due to the similarity of UEs. In addition, an achievable uplink transmission rate of a UE is closely related to the channel allocation strategy and the inter-cell interference, and the closer BSs interfere with each other more. Therefore, before determining the offloading decision, a BS should pay more attention to the state information of the neighbor BSs of the BS.

To solve the above problems, a GatMARL algorithm is provided according to the present disclosure to solve the problem of task offloading and service caching in the multi-cell MEC network. Specifically, according to the present disclosure, a multi-agent environment is constructed as an undirected graph G(V,E), where V represents a set of nodes, each of the nodes represents an agent, and E represents a set of edges connecting the nodes. Due to the one-to-one correspondence, the BS, the agent, and the node represent the same object. Moreover, a graph attention value-decomposition network is used in the present disclosure to decompose the joint-action value function to a combination of local-action value functions based on attention relationships. Based on the graph attention, the spatial correlation between BSs may be determined, and the weights of the local-action value functions of the agents may be calculated. The architecture of centralized training with decentralized execution (CTDE) is adopted for learning in the present disclosure. In the centralized training, state information of all the agents in the environment may be accessed, and the network parameters of the agents are updated based on the state information. In execution, each of the BSs may determine an action for task offloading, channel allocation and service caching based on local observation information of the BS, without obtaining global state information.

Specifically, FIG. 4 shows an architecture of a GatMARL algorithm according to the present disclosure, which includes three independent modules: a local-action value network of an agent, a graph attention module, and a joint-action value mixing module.

Specifically, each of the agents is provided with a deep recurrent Q-network (DRQN) as a local-action value network of the agent, and the deep recurrent Q-network includes a gate recurrent unit (GRU) and a multilayer perceptron (MLP). As shown in FIG. 4, at the time instant t, a received local observation value

$${o}_{n}^{t}$$

and a previous action

$${a}_{n}^{t - 1}$$

are inputted to a DRQN of an agent n, and the DRON of the agent n outputs a local-action value function

$${Q}_{n} ( {τ}_{n}^{t} , {a}_{n}^{t} ) .$$

In the partial observable MEC network, the GRU-based Q-network may facilitates the agent remembering historical service caching, channel assignment actions and historical observation values, which is conducive to long-term learning.

Specifically, with the MARL algorithm based on value decomposition, the joint-action value function Qₜₒₜ(τ,a) is decomposed to local-action value functions to determine a strategy of each of the agents, where τ represents a joint action observation history and a represents a joint action. For example, Qₜₒₜ represents a sum of local-action value functions in a value decomposition network (VDN), and QMIX decomposes Qₜₒₜ into a weighted sum of local-action value functions by using a hyper network. In a dense MEC system based on OFDMA, weights of local-action value functions of an agent are affected by all neighbor agents of the agent due to the spatial correlation of service type requests and wireless network states. Therefore, a graph attention value decomposition network is provided according to the present disclosure to learn an appropriate Qₜₒₜ.

As shown in FIG. 4, the environment state s^{t} is encoded as a local latent representation vector

$$( {h}_{1}^{t} , {h}_{2}^{t} , … , {h}_{N}^{t} )$$

by using a shared MLP encoder. Then, the local latent representation vector is inputted to the GAT network to adaptively capture the correlation between agents. The multi-agent environment is constructed as an undirected graph G in the present disclosure. At the time instant t, a feature of each of the nodes n is expressed as a local latent representation vector

$${h}_{n}^{t} ,$$

and each of the nodes n has a set Bₙ⊆N of neighbor nodes that is determined by the set E of edges. In the present disclosure, nodes having an edge between each other are neighbors.

In GAT, an attention coefficient e_{n,i} between the node n and a neighbor node i (i∈Bₙ) of the node n may be calculated by using the equation of

$${e}_{n , i} = att ( {Wh}_{n}^{t} , {Wh}_{i}^{t} ) ,$$

where att(⋅) represents a self-attention mechanism and W represents a learnable weight matrix. The attention coefficient e_{n,i} indicates an importance of the feature of the node n to the neighbor node i of the node n. In the present disclosure, only first-level neighbors (including node n) of the node n are considered. As shown in the following equation (18), the attention coefficient is normalized by using a softmax function, facilitating comparison between different nodes:

$${α}_{n , i} = soft {max}_{i} ( {e}_{n , i} ) = \frac{exp ( {e}_{n , i} )}{{\sum }_{j ∈ {B}_{n}} exp ( {e}_{n , j} )} \qquad ( 18 )$$

where α_{n,i} represents a normalized attention coefficient obtained by normalizing the attention coefficient e_{n,i}. To stabilize the learning process, a multi-head attention mechanism is adopted in the present disclosure. After obtaining the normalized attention coefficient, an output feature representation vector

$${h}_{n}^{′ t}$$

of a node n having L independent attention mechanisms may be expressed as:

$${h}_{n}^{′ t} = {‖}_{l = 1}^{L} σ ( {\sum }_{i ∈ {B}_{n}} {α}_{n , i}^{l} {W}^{l} {h}_{i}^{t} ) \qquad ( 19 )$$

where σ represents a nonlinear function, ∥ represents a splicing operation, and l represents a serial number of an attention mechanism. With the graph attention mechanism,

$${h}_{n}^{′ t}$$

represents an attention-based feature between nodes. The

$${h}_{n}^{′ t}$$

of the agent n is inputted to the MLP network, and the MLP network generates a weight

$${w}_{n}^{t}$$

for the local-action value function of the agent n.

According to the above analysis, a graph attention weight

$${\{ {w}_{n}^{t} \}}_{n ∈ N}$$

of the hybrid module may be obtained. The joint-action value function Qₜₒₜ may be decomposed as:

$${Q}_{tot} ( τ , a ) = {\sum }_{n ∈ N} {w}_{n}^{t} {Q}_{n} ( {τ}_{n}^{t} , {a}_{n}^{t} ) \qquad ( 20 )$$

Finally, the GatMARL is trained by using a minimum loss function, which is expressed as:

$$L ( θ ) = {\sum }_{x = 1}^{X} ( {y}_{t o t}^{x} - {Q}_{t o t} ( τ , a ; θ ) ) \qquad ( 21 )$$

$${y}_{t o t} = r + γ {max}_{{a}^{′}} {Q}_{t o t} ( {τ}^{′} , {a}^{′} ; {θ}^{-} ) \qquad ( 22 )$$

where θ represents a parameter of a predicting network (that is, the graph attention multi-agent reinforcement learning network), X represents the number of samples randomly sampled from an experience replay pool, x represents a sample number, θ⁻ represents a target network parameter, r represents rewards of all the agents in a current time slot, γ represents a discount factor, τ′ represents an observation history of a joint action of all the agents in a next time slot, a′ represents the joint action of all the agents in the next time slot, and Qₜₒₜ( ) represents a joint action-value function of all the agents in the current time slot.

In a fifth embodiment, to verify the effectiveness of the method according to the embodiments of the present disclosure, relevant simulation experiments are performed. The method for collaborative task offloading and service caching based on graph attention multi-agent reinforcement learning (GatMARL) is simulated and verified by using a Pytorch platform and an Adam optimizer according to the present disclosure. To verify the performance of the method according to the present disclosure, the following algorithms are used: an independent Q-learning (IQL) algorithm, a VDN algorithm, a QMIX algorithm and a GATMAR-OL algorithm.

For the independent Q-learning (IQL) algorithm, BSs are allowed to explore and learn independently based on local observations. In the method for task offloading and service caching based on IQL, a local BS, not caching a requested service, migrates a task to another BS that have cached the service for execution based on service cache information shared among BSs at a beginning of each of time instants.

For the VDN algorithm, the joint-action value function is directly decomposed into a sum of local-action value functions of all the agents without considering the spatial correlation of service request types and wireless network states among BSs.

For the QMIX algorithm, the joint-action value function is decomposed into a weighted sum of local-action value functions by using a hyper network. Similarly, in the method for task offloading and service caching based on QMIX, the spatial correlation among BS agents is not considered.

For the GatMARL-OL algorithm, different from the GatMARL algorithm, the GATMAR-OL algorithm only processes tasks in local BSs.

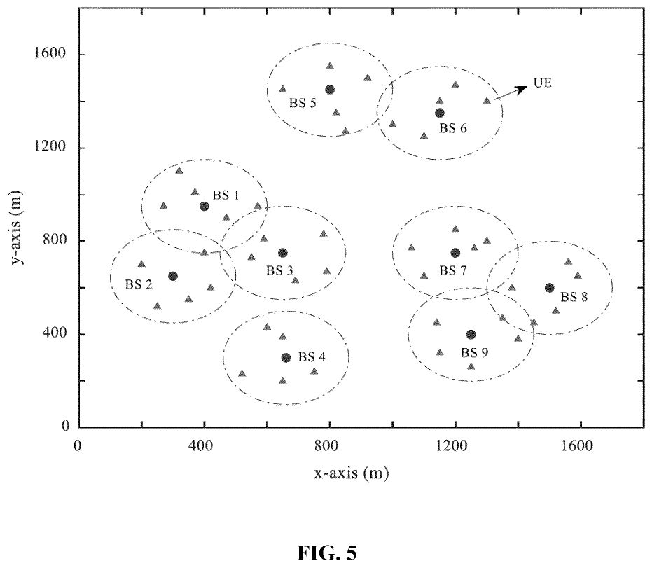

FIG. 5 shows a simulation scenario according to the present disclosure, in which nine BSs with predetermined position coordinates are arranged in an area of 1600 m*1600 m. Each of the base stations has a coverage radius of 200 m, and provides services for five randomly mobile UEs uniformly distributed in the coverage area of the base station. In the present disclosure, the BSs are divided into four clusters {BS1, BS2, BS3}, {BS4}, {BS5, BS6} and {BS7, BS8, BS9} based on the distances between the BSs, and the BSs in a same cluster are neighbors to each other. d⁻² represents a channel gain, where d represents a distance between a transmitter and a receiver. A transmission power pₘ_{ₙ} of a UE is evenly distributed within a range of [5 dBm, 33 dBm]. An average transmission rate r̅_{n,n′} between BSs is set to 10 Mbps. The amount

$${d}_{{m}_{n}}^{t}$$

of task data of a generated task is evenly distributed within a range of [10 Mbit, 30 Mbit]. The number

$${ρ}_{{m}_{n}}^{t}$$

of CPU cycles required for each bit of data is evenly distributed within a range of [500 cycles/bit, 1000 cycles/bit]. In the present disclosure, 20 service types with randomly determined storage requirements within a range of [10 GB, 20 GB] are configured. Each of base stations is configured with a storage capacity Zₙ of 100 GB. 16 orthogonal channels are set, and each of the channels is configured with a bandwidth of 10 MHz. The background noise δ² is set to −50 dBm. In the experiment, different services have different latency requirements related to the latency thresholds

$$( {T}_{{m}_{n}}^{t , min} , {T}_{{m}_{n}}^{t , fair} , {T}_{{m}_{n}}^{t , max} ) .$$

In the present disclosure, three latency threshold categories are predetermined for the service requirements of the UEs. That is, a latency threshold for latency-sensitive services such as virtual reality is set to (0.5 s, 1.25 s, 2.5 s), a latency threshold for cloud-based games is set to (1.25 s, 2.5 s, 3.75 s), and a latency threshold for latency-tolerant services such as web services is set to (2.5 s, 12.5 s, 20 s). A latency threshold of a service is determined based on the above three latency threshold categories.

It is assumed that a UE generates a task in each of time slots and the service preference follows a Zipf distribution. A popularity ranking of a service k in a BS is represented by [symbol] _{n,k}∈K, then a popularity of the service k may be expressed as:

$${ϕ}_{n , k} = \frac{{ℓ}_{n , k}^{- {δ}_{n}}}{{\sum }_{i ∈ K} {ℓ}_{n , i}^{- {δ}_{n}}} \qquad ( 23 )$$

where δₙ represents a skewness coefficient of a popularity in a BSn. In the experiment, the skewness coefficient is 0.8 for all the BSs unless otherwise stated. In the present disclosure, a popularity vector φₙ={φ_{n,1}, φ_{n,2}, . . . , φ_{n,K}} is defined for each BSn. Each of the UEs generates a task with a specific service requirement based on φₙ of a local BS of the UE. To simulate regional popularity of service requirements, different popularity vectors are configured for different clusters according to the present disclosure. Specifically, the service popularities of each of the clusters are randomly sorted based on to a service catalog in the network.

For the GatMARL algorithm and the GatMAR-OL algorithm, a GAT layer with four attention heads is adopted in the present disclosure, and the attention mechanism att(⋅) is a single-layer feedforward neural network activated by a LeakyReLU activation function. A dimension of a hidden layer of the GRU layer is set to 64, and a dimension of a hybrid network hidden layer of QMIX is set to 64. In the present disclosure, an exploration rate is set to decrease from 1 to 0.05 in 1000000 time slots, and a learning rate is 0.0005. In addition, to improve the learning efficiency of the decision model, the local BS offloading action is removed (that is,

$${b}_{{m}_{n}}^{t} = n )$$

in the present disclosure, and a local BS service caching state is used to represent

$${b}_{{m}_{n}}^{t} = n .$$

That is, in a case that the local BS caches a corresponding service type, the agent directly performs the local BS offloading action without further exploration.

According to the present disclosure, the GatMARL algorithm is verified from three performance indicators of utility, calculation success rate and cache hit rate. The calculation success rate is equal to a result of dividing the number of tasks successful processed by the MEC system in a maximum time threshold by the total number of tasks. The cache hit rate is equal to a result of dividing the number of tasks processed at the local base station by the total number of tasks in the network.

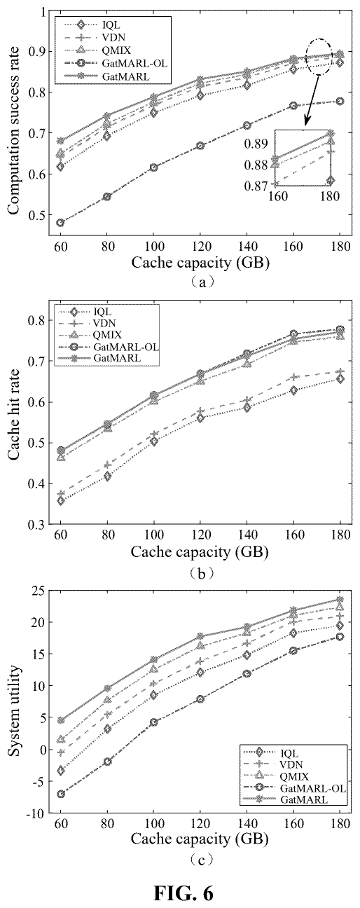

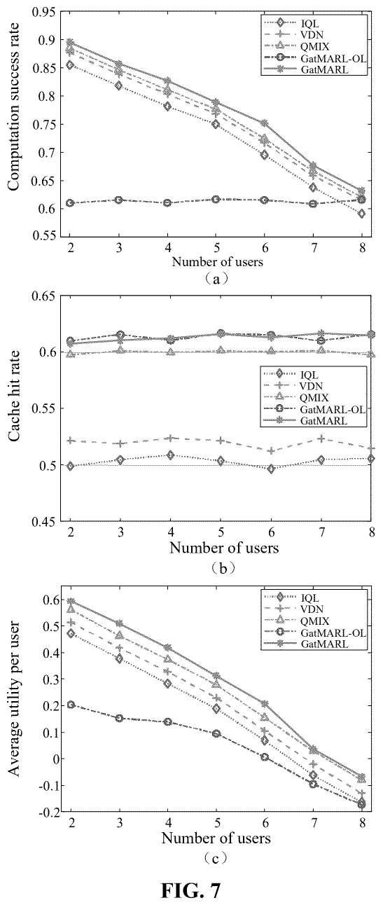

FIG. 5 shows the effect of the storage capacity of the BSs on the system utility, the computation success rate, and the cache hit rate. In this experiment, the storage capacity of each of the BSs is set to be in a range from 60 to 180 with a step size of 20, and other parameters are the default values mentioned above. It can be seen from FIG. 6(a) that the curve shows an upward trend as the storage capacity of the BSs increases. A BS, having a larger storage capacity, may cache more services, thereby meeting more requests from UEs of the local BS or other BSs in the network and improving the computation success rate. Similarly, as shown in FIG. 6(b), the cache hit ratio increases as the storage capacity increases due to that more popular services may be cached in the local BS. The improvement of the computation success rate and the cache hit rate indicates the improvement of the system utility as shown in FIG. 6(c). Compared with the conventional technology, the method for task offloading and service caching based on GATMARL-based according to the present disclosure has a best performance.

FIG. 7 shows the performance of different algorithms with different numbers of UEs. In this experiment, the number of UEs of each of the BSs is set to be in a range of 2 to 8 according to the present disclosure, and other parameters are set to default values. As shown in FIG. 7(a), the offloading success rates, based on the IQL algorithm, the VND algorithm, the QMIX algorithm and the GatMARL algorithm, are inversely proportional to the number of UEs. As the number of UEs increases, the inter-cell interference increases, thus the uplink transmission latency from a UE to the local BS increases, resulting in task offloading failure especially in a cooperative offloading mode with additional inter-BS transmission latency. It can be seen from FIG. 7(b) that all the algorithms almost have a constant local hit bites for different numbers of UEs. It can be seen from the trends of the curves that the agent may always learn an effective service caching strategy based on the historical request service type state of the UEs. FIG. 7(c) shows an average utility of a UE achieved using different algorithms for different numbers of UEs. It can be seen that the utility gradually decreases as the number of UEs increases due to that the decrease in computation success rate leads to a decrease in the utility. In addition, according to the equation (11), an increase in the transmission latency from a UE to the local BS may lead to a decrease in utility. Furthermore, it can be seen from FIG. 7 that the GatMARL algorithm is significantly better than the other algorithms for different numbers of UEs.

In the present disclosure, otherwise clear specification and limitation are provided, terms such as “installation”, “arrangement”, “connection”, “fixing” and “rotation” should be understood in a broad sense, such as a fixed connection, a detachable connection or an integral connection; a mechanical connection or an electrical connection; a direct connection or an indirect connection through an intermediate media, or an internal connection inside two components or the interaction between the two components. Otherwise clear limitation is provided, for those skilled in the art, the specific meaning of the above terms in the present disclosure may be understood in the light of specific circumstances.

Although the embodiments of the present disclosure are shown and described, those skilled in the art can understand that various changes, modifications, substitutions and alterations can be made to these embodiments without departing from the principle and purpose of the present disclosure, and the scope of the present disclosure is defined by the claims and their equivalents.

1. A method for collaborative task offloading and service caching based on graph attention multi-agent reinforcement learning, comprising:
step S1, constructing an MEC system in a scenario of an MEC network with a plurality of base stations and diverse service requests, wherein each of the base stations in the MEC system is provided with an MEC server for providing caching and computing resources of a computing service for a user equipment associated with the base station; N={1, 2, . . . , N} represents a set of base stations, where N=|N| and represents the number of the base stations; Mₙ={1, 2, . . . , Mₙ} represents a set of user equipments associated with a base station n∈N, where Mₙ=|Mₙ| represents the number of the user equipments associated with the base station n; the MEC system has dynamic time slots, T={0, 1, 2, . . . } represents a set of time slots, and each of the time slots has a same time length and is represented by t∈T; and the MEC system further comprises a task model, a service caching model, a communication model, a task offloading model and a utility model;
step S2, modeling, based on the MEC system, a coordinative task offloading and service caching problem for maximizing a system utility based on QoE;
step S3, transforming the coordinative task offloading and service caching problem to a decentralized partial observable Markov decision process, comprising:
step S31, transforming the coordinative task offloading and service caching problem to the decentralized partial observable Markov decision process with the N base stations, wherein each of the base stations serves as an agent; and
step S32, configuring an environment state space, a local observation space, an action space, and a reward function; and
step S4, solving the decentralized partial observable Markov decision process by using a graph attention multi-agent reinforcement learning algorithm, comprising:
step S41, constructing a graph attention multi-agent reinforcement learning network, wherein the graph attention multi-agent reinforcement learning network comprises a graph attention module, a joint action-value hybrid module, and a local action-value network corresponding to each of the agents;
step S42, for each of the agents, inputting a local observation value received by the agent and a previous action to a local action-value network corresponding to the agent, and outputting a local action-value function;
step S43, inputting an environment state of the MEC system to the graph attention module and outputting a weight of the local action-value function, by the graph attention module;
step S44, summing, by the joint action-value hybrid module, all local action-value functions based on the weights to obtain a joint action-value function, and training the joint action-value function by using a minimum loss function; and
step S45, obtaining a globally optimal strategy for task offloading and service caching based on local observation values of the base stations.

2. The method for collaborative task offloading and service caching based on graph attention multi-agent reinforcement learning according to claim 1, wherein the task model is constructed by:
periodically generating, by each of the user equipments, computing tasks with different QoEs and different service requirements;
wherein K={1, 2, . . . , K} represents a set of service types in the MEC system, and K=|K| represents the number of the service types; a computing task generated by a user equipment mₙ∈Mₙ at a time instant t comprises six parameters and is represented by
$${φ}_{{m}_{n}}^{t} = \{ {d}_{{m}_{n}}^{t} , {ψ}_{{m}_{n}}^{t} , {ρ}_{{m}_{n}}^{t} , {T}_{{m}_{n}}^{t , min} , {T}_{{m}_{n}}^{t , max} , {T}_{{m}_{n}}^{r , fair} \} ; {d}_{{m}_{n}}^{t}$$
represents the amount of task data of the computing task generated by the user equipment mₙ at the time instant t;
$${ψ}_{{m}_{n}}^{t} ∈ K$$
represents a service type of the computing task generated by the user equipment mₙ at the time instant t;
$${ρ}_{{m}_{n}}^{t}$$
represents the number of CPU cycles required for each bit of input data of the computing task generated by the user equipment mₙ at the time instant t;
$${T}_{{m}_{n}}^{t , min} , {T}_{{m}_{n}}^{t , max} , and {T}_{{m}_{n}}^{t , fair}$$
represent three predetermined service latency thresholds based on the service type of the computing task generated by the user equipment mₙ at the time instant;
$${T}_{{m}_{n}}^{t , max}$$
represents a minimum service latency threshold;
$${T}_{{m}_{n}}^{t , max}$$
represents a maximum service latency threshold; and
$${T}_{{m}_{n}}^{t , fair} ∈ [ {T}_{{m}_{n}}^{t , min} , {T}_{{m}_{n}}^{t , max} ]$$
represents a critical latency at which the user equipment mₙ determines a poor QoE.

3. The method for collaborative task offloading and service caching based on graph attention multi-agent reinforcement learning according to claim 1, wherein the service caching model is constructed by:
executing, based on a service cached in a base station at a time slot t, a task at a time slot t+1;
wherein a binary variable
$${β}_{n , k}^{t} ∈ \{ 0 , 1 \}$$
represents a service caching decision of a service k in a base station n at the time slot t,
$${β}_{n , k}^{t} = 1$$
in a case that the service k is cached in the base station n, and
$${β}_{n , k}^{t} = 0$$
in a case that the service k is not cached in the base station n.

4. The method for collaborative task offloading and service caching based on graph attention multi-agent reinforcement learning according to claim 1, wherein the communication model is constructed by:
dividing a bandwidth of the MEC system into C orthogonal channels;
wherein the C orthogonal channels are assigned in each of the time slots, and the orthogonal channels fully multiplex spectrum resources of the MEC system; C={1, 2, . . . , C} represents a set of available channels of each of the base stations, and
$${α}_{{m}_{n}}^{t , c} ∈ \{ 0 , 1 \}$$
represents a channel assignment variable of the base station n at a time slot t,
$${α}_{{m}_{n}}^{t , c} = 1$$
in a case that the base station n assigns a channel c∈C to a user equipment mₙ, and
$${α}_{{m}_{n}}^{t , c} = 0$$
in a case that the base station n does not assign the channel c∈C to the user equipment mₙ; it is assumed that
$${g}_{{m}_{n} , n}^{t , c}$$
represents a channel gain between the user equipment mₙ and the local base station n of the user equipment mₙ on the channel c in the time slot t, then an uplink transmission rate
$${r}_{{m}_{n} , n}^{t , c}$$
of the user equipment mₙ on the channel c in the time slot t is expressed as:
$${r}_{{m}_{n} , n}^{t , c} = w {log}_{2} ( 1 + \frac{{p}_{{m}_{n}} {g}_{{m}_{n} , n}^{t , c}}{{σ}^{2} + {I}_{n}^{t , c}} )$$
and an uplink transmission rate
$${r}_{{m}_{n} , n}^{t}$$
of the user equipment mₙ at the local base station n in the time slot t is expressed as:
$${r}_{{m}_{n} , n}^{t} = {\sum }_{c ∈ C} {α}_{{m}_{n}}^{t , c} {r}_{{m}_{n} , n}^{t , c}$$
where w represents a bandwidth of a channel, pₘ_{ₙ} represents a transmission power of the user equipment mₙ, σ² represents a background noise power, and
$${I}_{n}^{t , c}$$
represents an interference received by the base station n from other user equipments on the channel c in the time slot t.

5. The method for collaborative task offloading and service caching based on graph attention multi-agent reinforcement learning according to claim 1, wherein the task offloading model is constructed by:
determining a local base station offloading strategy and a collaborative offloading strategy for a computing task of each of the user equipments; wherein
$${b}_{{m}_{n}}^{t} ∈ \{ 0 \} ⋃ N$$
represents a task offloading decision of a user equipment mₙ in a time slot t,
$${b}_{{m}_{n}}^{t} = n$$
in a case that the computing task generated by the user equipment mₙ at a time instant t is offloaded to a local base station n of the user equipment mₙ for execution,
$${b}_{{m}_{n}}^{t} = {n}^{′}$$
in a case that the computing task generated by the user equipment mₙ at the time instant t is offloaded to a base station n′∈N\{n} for execution, and
$${b}_{{m}_{n}}^{t} = 0$$
in a case that the computing task generated by the user equipment mₙ at the time instant t is discarded, wherein the time slot t represents a time period and the time instant t represents a start time instant of the time slot t;
in a case of selecting the local base station offloading strategy,
calculating an uplink latency
$${T}_{{m}_{n} , n}^{t , tran}$$
for transmitting the computing task generated by the user equipment mₙ at the time instant t to the local base station n of the user equipment mₙ by using the following equation:
$${T}_{{m}_{n} , n}^{t , tran} = \frac{{d}_{{m}_{n}}^{t}}{{r}_{{m}_{n} , n}^{t}}$$
where
$${d}_{{m}_{n}}^{t}$$
represents the amount of task data of the computing task generated by the user equipment mₙ at the time instant t, and
$${r}_{{m}_{n} , n}^{t}$$
represents an uplink transmission rate of the user equipment mₙ at the local base station n in the time slot t;
calculating a task computing latency
$${T}_{{m}_{n} , n}^{t , comp}$$
of the computing task of the user equipment mₙ at the local base station n by using the following equation:
$${T}_{{m}_{n} , n}^{t , comp} = \frac{{d}_{{m}_{n}}^{t} {ρ}_{{m}_{n}}^{t}}{{f}_{n}}$$
where fₙ represents a CPU frequency of the base station n, and
$${ρ}_{{m}_{n}}^{t}$$
represents the number of CPU cycles required for each bit of input data of the computing task generated by the user equipment mₙ at the time instant t;
calculating a processing latency
$${T}_{{m}_{n} , n}^{t}$$
for offloading the computing task generated by the user equipment mₙ at the time instant t to the local base station n of the user equipment mₙ by using the following equation:
$${T}_{{m}_{n} , n}^{t} = {T}_{{m}_{n} , n}^{t , tran} + {T}_{{m}_{n} , n}^{t , comp}$$
in a case of selecting the cooperative offloading strategy,
calculating, due to that an additional transmission latency is generated by migrating the computing task generated by the user equipment mₙ at the time instant t to a base station n′, an uplink latency
$${T}_{{m}_{n} , {n}^{′}}^{t , tr a n}$$
for transmitting the computing task generated by the user equipment mₙ at the time instant t to the base station n′ by using the following equation:
$${T}_{{m}_{n} , {n}^{′}}^{t , tran} = \frac{{d}_{{m}_{n}}^{t}}{{r}_{{m}_{n} , n}^{t}} + \frac{{d}_{{m}_{n}}^{t}}{{\overline{r}}_{n , {n}^{′}}}$$
where r̅_{n,n′} represents an average transmission rate between the base station n and the base station n′;
calculating a task computing latency
$${T}_{{m}_{n} , {n}^{′}}^{t , comp}$$
of the computing task of the user equipment mₙ at the base station n′ by using the following equation:
$${T}_{{m}_{n} , {n}^{′}}^{t , comp} = \frac{{d}_{{m}_{n}}^{t} {ρ}_{{m}_{n}}^{t}}{{f}_{{n}^{′}}}$$
where f_{n′} represents a CPU frequency of the base station n′; and
determining a processing latency
$${T}_{{m}_{n} , {n}^{′}}^{t}$$
for offloading the computing task generated by the user equipment mₙ at the time instant t to the base station n′ by using the following equation:
$${T}_{{m}_{n} , {n}^{′}}^{t} = {T}_{{m}_{n} , {n}^{′}}^{t , tran} + {T}_{{m}_{n} , {n}^{′}}^{t , comp}$$

6. The method for collaborative task offloading and service caching based on graph attention multi-agent reinforcement learning according to claim 1, wherein the utility model is constructed by:
defining a utility function to evaluate a quality of experience of the user equipment, wherein the utility function is expressed as:
$${U}_{{m}_{n}}^{t} = \{ \begin{matrix}1 , & 0 < {T}_{{m}_{n}}^{t} \leq {T}_{{m}_{n}}^{t , min} \\ \frac{{T}_{{m}_{n}}^{t , max} - {T}_{{m}_{n}}^{t}}{{T}_{{m}_{n}}^{t , max} - {T}_{{m}_{n}}^{t , min}} , & {T}_{{m}_{n}}^{t , min} < {T}_{{m}_{n}}^{t} \leq {T}_{{m}_{n}}^{t , max} \\ - 1 , & others\end{matrix}$$
where
$${U}_{{m}_{n}}^{t}$$
represents an utility obtained by a user equipment mₙ in a time slot t,
$${T}_{{m}_{n}}^{t}$$
represents a service latency for processing a computing task generated by the user equipment mₙ at the time instant t,
$${T}_{{m}_{n}}^{t , min}$$
represents a minimum service latency requirement of the computing task generated by the user equipment mₙ at the time instant t, and
$${T}_{{m}_{n}}^{t , max}$$
represents a maximum service latency requirement of the computing task generated by the user equipment mₙ at the time instant t.

7. The method for collaborative task offloading and service caching based on graph attention multi-agent reinforcement learning according to claim 1, wherein the step S32 of configuring an environment state space, a local observation space, an action space and a reward function comprises:
in the environment state space, defining
$${s}^{t} = \{ {φ}^{t} , {β}^{t - 1} , {\{ {g}_{n , n}^{t} , {g}_{{n}^{′} , n}^{t} \}}_{n ∈ N , {n}^{′} ∈ N ∖ \{ n \}} \}$$
where s^{t} represents an environment state of the MEC system in a time slot t;
$${φ}^{t} = {\{ {φ}_{{m}_{n}}^{t} \}}_{n ∈ N , {m}_{n} ∈ {M}_{n}}$$
represents a set of task computing requirement information requested by all the user equipments at the time instant t;
$${φ}_{{m}_{n}}^{t}$$
represents a computing task generated by a user equipment mₙ at the time instant t;
$${g}_{n , n}^{t} = {\{ {g}_{{m}_{n} , n}^{t , c} \}}_{{m}_{n} ∈ {M}_{n} , c ∈ C}$$
represents a set of channel gains of all user equipments associated with the base station n on a channel;
$${g}_{{m}_{n} , n}^{t , c}$$
represents a channel gain between the user equipment mₙ and a local base station n of the user equipment mₙ on a channel c in the time slot t;
$${g}_{{n}^{′} , n}^{t} = {\{ {g}_{{m}_{{n}^{′}} , n}^{t , c} \}}_{{n}^{′} ∈ N ∖ \{ n \} , {m}_{{n}^{′}} ∈ {M}_{{n}^{′}} , c ∈ C}$$
represents a set of interference channel gains between other user equipments and the base stations n on a channel;
$${g}_{{m}_{{n}^{′}} , n}^{t , c}$$
represents an interference channel gain between a user equipment m_{n′} and the base station n on the channel c in the time slot t; and
$${β}^{t - 1} = {\{ {β}_{n , k}^{t - 1} \}}_{n ∈ N , k ∈ K}$$
represents a set of service caching decisions in a time instant t−1;
in the local observation space, defining
$${o}_{n}^{t} = \{ {φ}_{n}^{t} , {β}^{t - 1} , {g}_{n , n}^{t} \}$$
where
$${o}_{n}^{t}$$
represents a local observation value of an agent n in the time slot t;
in the action space, defining
$${a}_{n}^{t} = \{ {β}_{n}^{t} , {α}_{n}^{t} , {b}_{n}^{t} \}$$
where
$${a}_{n}^{t}$$
represents an action space of the agent n in the time slot t,
$${β}_{n}^{t} = {\{ {β}_{n , k}^{t} \}}_{k ∈ K}$$
represents a service caching decision of the agent n, and
$${β}_{n , k}^{t}$$
represents a service caching decision of a service k in the base station n in the time slot t,
$${α}_{n}^{t} = {\{ {α}_{{m}_{n}}^{t , c} \}}_{{m}_{n} ∈ {M}_{n} , c ∈ C}$$
represents channel allocation decisions of all user equipments within a coverage region of the agent n,
$${α}_{{m}_{n}}^{t , c}$$
represents a channel allocation variable of the user equipment mₙ in the time slot t,
$${b}_{n}^{t} = {\{ {b}_{{m}_{n}}^{t} \}}_{{m}_{n} ∈ {M}_{n}}$$
represents task offloading decisions of all the user equipments within the coverage region of the agent n, and
$${b}_{{m}_{n}}^{t}$$
represents a task offloading decision of the user equipment mₙ in the time slot t; and
defining the reward function as:
$${r}^{t} = R ( {s}^{t} , {a}^{t} ) = {\sum }_{n ∈ N} {\sum }_{{m}_{n} ∈ {M}_{n}} {U}_{{m}_{n}}^{t}$$
where r^{t} represents rewards obtained by all agents in the time slot t, a^{t} represents a joint action of all the agents in the time slot t,
$${U}_{{m}_{n}}^{t}$$
represents a utility obtained by the user equipment mₙ in the time slot t, and R( ) represents a reward function related to s^{t} and a^{t}.

8. The method for collaborative task offloading and service caching based on graph attention multi-agent reinforcement learning according to claim 1, wherein the step S43 of inputting an environment state of the MEC system to the graph attention module and outputting a weight of the local action-value function by the graph attention module comprises:
step S431, constructing a multi-agent environment of the MEC system as an undirected graph G(V,E), wherein V represents a set of nodes, each of the nodes represents an agent, E represents a set of edges connecting the nodes, and each of the nodes has a set Bₙ⊆N of neighbor nodes determined by the set E of edges;
step S432, inputting the environment state s^{t} to an MLP encoder at the time slot t to output a local latent representation vector
$$( {h}_{1}^{t} , {h}_{2}^{t} , ⋯ , {h}_{N}^{t} ) ,$$
and inputting the local latent representation vector to a GAT network, wherein
$${h}_{n}^{t}$$
represents a local latent representation vector of the node n;
step S433, calculating, for each of the node, an attention coefficient between the node and a neighbor node of the node using a self-attention mechanism of the GAT network, and normalizing the attention coefficient using a softmax function to obtain a normalized attention coefficient; and
step S434, calculating, for each of the node, an output feature representation vector of the node using a multi-head attention mechanism based on the normalized attention coefficient, and inputting the calculated output feature representation vector to the MLP network to obtain the weight of the local action-value function of each of the agents.

9. The method for collaborative task offloading and service caching based on graph attention multi-agent reinforcement learning according to claim 1, wherein the loss function in step S44 is expressed as:
$$L ( θ ) = {\sum }_{x = 1}^{X} ( {y}_{t o t}^{x} - {Q}_{t o t} ( τ , a ; θ ) )$$
$${y}_{t o t} = r + γ {max}_{{a}^{′}} {Q}_{t o t} ( {τ}^{′} , {a}^{′} ; {θ}^{-} )$$
where θ represents a parameter of a prediction network, X represents the number of samples randomly sampled from an experience replay pool, x represents a sample number, θ⁻ represents a target network parameter, r represents rewards of all the agents in a current time slot, γ represents a discount factor, τ′ represents an observation history of a joint action of all the agents in a next time slot, a′ represents the joint action of all the agents in the next time slot, and Qₜₒₜ( ) represents a joint action-value function of all the agents in the current time slot.
